(19) United States
(12) Patent Application Publication
(10) Pub. No.: US 2004/0250486 A1
(43) Pub. Date: Dec. 16, 2004

(54) Injection molded thermoplastic door sill-to-jamb kit

(75) Inventor: Peter Sibbett, Tacoma, WA (US)

Correspondence Address: DARBY & DARBY P.C., P. O. BOX 5257, NEW YORK, NY, 10150-5257, US

(73) Assignee: Trinity Glass International, Tacoma, WA

(21) Appl. No.: 10/865,105

(22) Filed: Jun. 10, 2004

Related U.S. Application Data
(60) Provisional application No. 60/478,496, filed on Jun. 13, 2003.

(51) Int. Cl. E06B 1/04

(52) U.S. Cl. 52/204.1; 52/211

(57) ABSTRACT

A door sill-to-jamb kit manufactured from rot-resistant thermoplastic material is placed between a bottom of a side jamb and a sill of a door frame assembly. Parallel tenons fitting into mortises at the base of the side jamb and fasteners secure the door sill-to-jamb kit to the side jamb as well as to the door sill. Elevated height of the side jamb prevents contact with moisture on the surface of door sill and between the door sill-to-jamb kit and the door sill, thus reducing a risk of rotting of the wooden side jamb.

### RELATED APPLICATION

This application claims the benefit of U.S. Provisional Application Serial No. 60/478,496 filed Jun. 13, 2003, the benefit of the earlier filing date of which is hereby claimed under 35 U.S.C. §119 (e).

### FIELD OF THE INVENTION

The present invention relates to plastic articles and, in particular, a plastic door sill- to-jamb kit attachable to a sill and jamb, formed by a thermoplastic injection molding process, and a method of making the door sill- to-jamb kit.

### BACKGROUND OF THE INVENTION

Traditionally, wooden door jambs have been directly attached to the side of a door sill. Likewise, doors evolved from a traditional wooden material to metal, plastic, particle board, fiberglass, and the like, for a variety of reasons. For example, this evolution attempted to address the weathering deficiency such as warping, cracking, peeling, rotting, and the like. Commonly, the weathering problem related to moisture exposure occurs at the bottom of the door and at the bottom of the door frame where sill and jambs are jointed. Another common problem of joining the sill to jamb is that jambs tend to split in the process of assembling or from the exposure to the weather.

Existing methods have tried to attack the problem of weathering within an entire door and side jamb, which limits the solution to the particular door and door jamb. Such limitation creates other problems including increased cost, redeveloping manufacturing systems to make such doors, compromising an integrity and esthetics of the door and side jamb, and the like.

Therefore, there is a need in the industry for an improved method of attaching a door sill to jambs to address weathering problems and the cost associated with difficulty in assembly due to splitting jambs and jamb misalignment. Thus, it is with respect to these considerations, and others, that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Preferred Embodiment, which is to be read in association with the accompanying drawings, wherein:

FIG. 1 illustrates a door system where the present invention may be practiced;

FIG. 2 illustrates a front angle isometric view of one embodiment of a door sill-to-jamb kit according to the present invention;

FIG. 3 illustrates a back angle isometric view of one embodiment of a door sill-to-jamb kit according to the present invention;

FIG. 4A illustrates a partial view of a door frame including a door sill-to-jamb kit according to the present invention attached to the sill and to the jamb; and

FIG. 4B illustrates a partial bottom isometric view of a door frame including a door sill-to-jamb kit according to the present invention attached to the sill and to the jamb.

### DETAILED DESCRIPTION OF THE PREFERRED EMBODIMENT

The present invention is directed to addressing the above-mentioned shortcomings, disadvantages and problems, and will be understood by reading and studying the following specification.

The present invention will now be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. The following detailed description is, therefore, not to be taken in a limiting sense.

Briefly stated, the present invention is directed towards a cost effective method of remedying detrimental effects of weathering at a door sill and a doorjamb bottom area..

Many exterior wooden door jambs may experience problems associated with rotting due to moisture. Even with protective finishes, the wooden exterior of a door jamb may be prone to water penetration that may in turn lead to rotting, especially at the bottom of a side jamb where water accumulation and wicking up the wood may be substantial. There have been attempts to address some of the disadvantages of wooden side jambs by employing steel, plastic, fiberglass, extruded wood composite, thermoplastics, urethane, and the like. Some of these alternate materials to wood have been effective, however, rotting of the side jamb bottom, when wood is employed, is not addressed by these methods. Yet another approach to address the detrimental effect of moisture exposure at the bottom of the side jamb employs a finger jointed composite bottom. These approaches of employing multiple materials often have manufacturing limitations, which may make them less desirable from a cost and manufacturing efficiency consideration.

Furthermore, multi-material doors and door jambs create an entirely separate type of door system, whereas the current method supplements an existing wood door system by attaching the jambs to the sill through a sill-to-jamb kit. This allows manufacture of rot resistant wood door systems as well as a system that is cost effective due to reduction of jamb splitting and ease of assembly through the use of alignment tabs and a sill-to-jamb joining method.

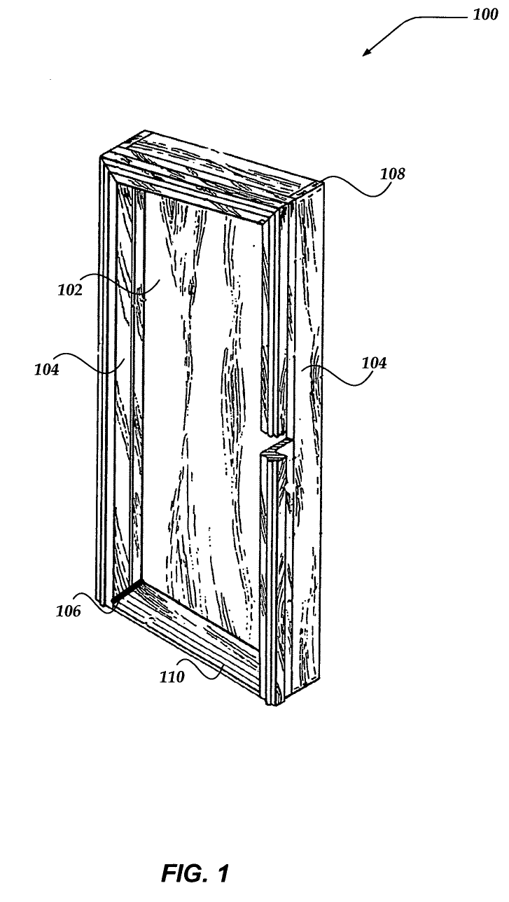

FIG. 1 illustrates door system 100 where the present invention may be practiced. Door system 100 comprises door 102, side jambs 104, door sill-to-jamb kit 106, door frame 108, and door sill 110.

Door frame 108 is positioned around an opening in a wall. Vertical sides of door frame 108 are side jambs 104. At least one side jamb 104 may include a protruding stop strip (not shown) for engaging door 102 when door 102 is in a closed position. The stop strip is part of side jamb 104, which is positioned over an exposed edge of the wall. Walls are of varying thickness, therefore, door frame 108 may also be available in various widths to accommodate varying walls. Door sill 110, commonly called threshold, is positioned at the bottom of door frame 108 between side jambs 104. Door sill-to-jamb kit 106 is positioned at the bottom of side jamb 104 connecting side jamb 104 and door sill 110. Door sill-to-jamb kit 106 generally comprises left and right units that are mirror opposites of each other, which attach left and right side jambs 104 to each end of door sill 110. Thus, the term door sill-to-jamb kit can refer to each unit individually and to a mirrored pair together.

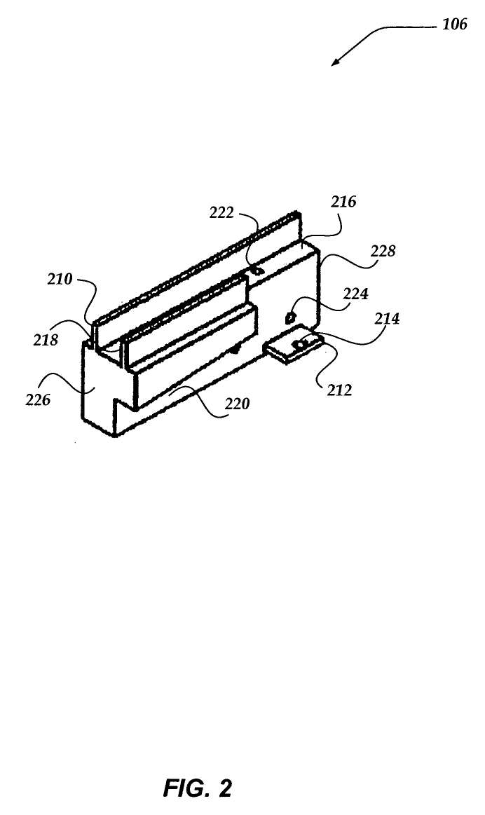

FIG. 2 shows a front angle isometric view of one embodiment of door sill-to-jamb kit 106 according to the present invention. Door sill-to-jamb kit 106 comprises top surface 216, side surface 220, front end 226, and back end 228. Door sill-to-jamb kit 106 further comprises tenon 210 and tenon 218 protruding vertically from top surface 216, tab 212 protruding vertically from side surface 220, at least one screw boss 222 through top surface 216, at least one screw boss 224 through side surface 220, and a screw boss 214 through tab 212.

Door sill-to-jamb kit 106 may be secured to the side jamb employing a number of conventional mechanisms including a mortise-tenon joint on top surface 216 of door sill-to-jamb kit 106, screw bosses 22, and the like. Door sill-to-jamb kit 106 is further secured to the door sill employing screw boss 214, screw bosses 224, and the like. A screw, a nail, a dowel, and the like, may be employed to secure door sill-to-jamb kit 106 to the side jamb and the door sill. A number of screw bosses 224 may be pre-selected.

As shown in the figure, Tenon 210 protrudes vertically from top surface 216 of door sill-to-jamb kit 106. Tenon 210 may extend from front end 226 to back end 228 of door sill-to-jamb kit 106. Tenon 218, parallel to tenon 210, may protrude from top surface 216 as well. A bottom end of the side jamb may be formed with a matching mortise structure fitting over tenons 210 and 218 mechanically securing the side jamb to door sill-to-jamb kit 106.

Tab 212 with screw boss 214, protruding at a right angle from side surface 220 of door sill-to-jamb kit 106, may provide a further securing mechanism allowing door sill-to-jamb kit 106 to be quickly aligned and fastened to the door sill.

Door sill-to-jamb kit 106 may be manufactured employing plastic, polyurethane, fiberglass, extruded wood composite, and the like. Door sill-to-jamb kit 106 may be further manufactured employing techniques such as injection molding, and the like.

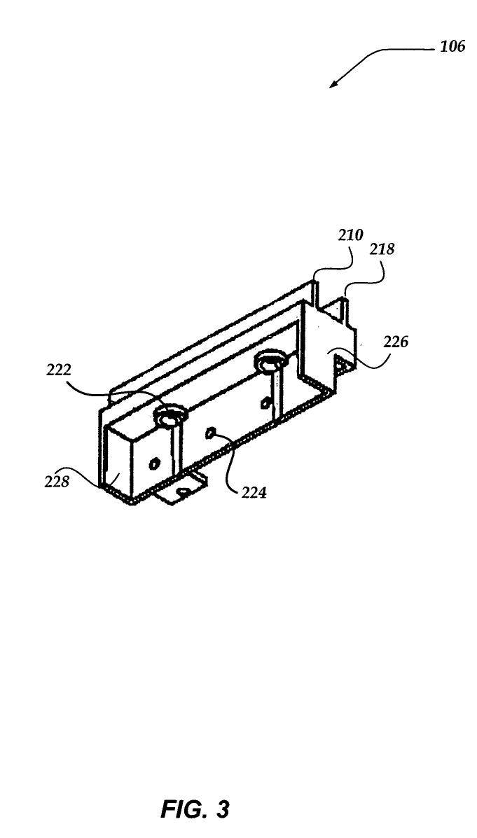

FIG. 3 illustrates a back angle isometric view of one embodiment of door sill-to-jamb kit 106 according to the present invention. Screw boss 222 provides a securing mechanism that allows fastening door sill-to-jamb kit 106 to the side jamb. Screw boss 224 provides a mechanism for fastening door sill-to-jamb kit 106 to the door sill of the door frame. As mentioned above, the number of screw bosses 222 and 224 may be pre-selected based, in part, on a length of door sill-to-jamb kit 106. Front end 226 and back end 228, as well as tenons 210 ad 218 are shown for reference to FIG. 2.

The length of door sill-to-jamb kit 106 may be pre-selected to accommodate varying door frame widths. For example, in one embodiment, the length of door sill-to-jamb kit 106 may be selected to accommodate door frame widths between 4 inches and 9 inches.

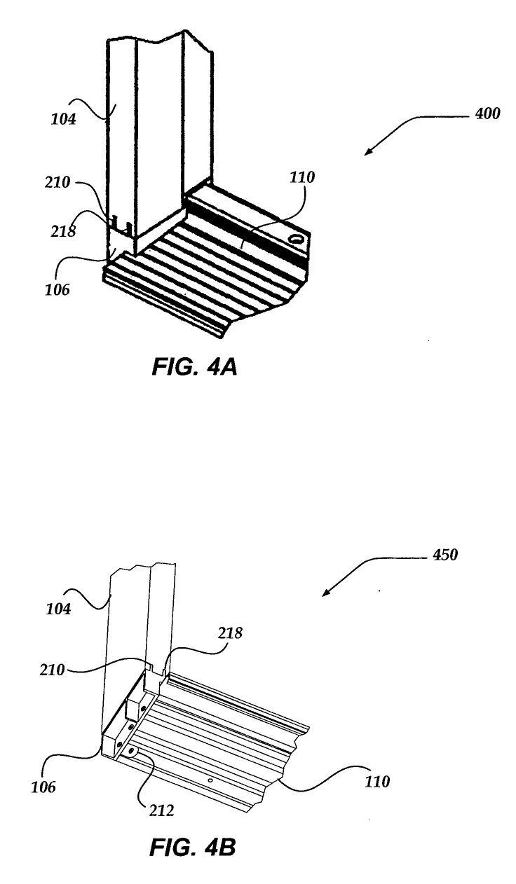

FIG. 4A illustrates a partial view 400 of a door frame including door sill-to-jamb kit 106 according to the present invention attached to the bottom of side jamb 104 and door sill 110. As shown in the figure, side jamb 104 is secured by a mortise-tenon structure, including tenons 210 and 218, to door sill-to-jamb kit 106. Door sill-to-jamb kit 106, manufactured from a thermoplastic material fits at the base of side jamb 104 along one end of door sill 110 of the door frame 108 of FIG. 1. A height of door sill-to-jamb kit 106 maybe selected in reference to side jamb 104 and door sill 110. Many weathering problems associated with door jambs are concentrated at the base of sidejamb 104 where moisture is more prevalent. In order to avoid exposing the base of side jamb 104 to weathering effects, the height of sill-to-jamb kit 106 should be higher than a height of door sill 110, preventing elevated wooden side jamb 104 from coming into contact with any sitting moisture on top of door sill 110 and between door sill-to-jamb kit 106 and door sill 110. Door sill-to-jamb kit 106 may be manufactured employing a number of rot-resistant materials as described above.

FIG. 4B illustrates a partial bottom isometric view 450 of the door frame including door sill-to-jamb kit 106 according to the present invention attached to the bottom of side jamb 104 and door sill 110. As described above, side jamb 104 is secured by tenons 210 and 218 to door sill-to-jamb kit 106. Door sill 110 is secured by tab 212 to door sill-to-jamb kit 106.

The above specification, examples, and data provide a complete description of the manufacture and use of the composition of the invention. Since many embodiments of the invention can be made without departing from the spirit and scope of the invention, the invention resides in the claims hereinafter appended.

We claim:

1. A door sill-to-jamb kit that is resistant to weathering effects on a wooden door frame assembly, comprising:
a substantially rectangular member consisting of at least a thermoplastic material, wherein a length of the member is substantially similar to a width of a side jamb of the door frame assembly;
at least one substantially elongated protrusion on a top surface of the member; and
at least one substantially flat tab protruding at a right angle from a lateral surface of the member.

2. The door sill-to-jamb kit of claim 1, wherein the thermoplastic material is at least one of plastic, polyurethane, fiberglass, and extruded wood composite.

3. The door sill-to-jamb kit of claim 1, wherein the member further comprises at least one substantially round hole between the top surface and a bottom surface.

4. The door sill-to-jamb kit of claim 3, wherein the door sill-to-jamb kit is fastened to the side jamb by employing at least one of a screw, a nail, a rivet, and a dowel through the substantially round hole.

5. The door sill-to-jamb kit of claim 1, wherein the at least one substantially elongated protrusion on the top surface fits into a substantially matching groove at a bottom surface of the side jamb.

6. The door sill-to-jamb kit of claim 1, wherein the at least one substantially flat tab protruding from a lateral surface is employed to fasten the door sill-to-jamb kit to a door sill.

7. The door sill-to-jamb kit of claim 1, wherein the length of the member is predetermined between 4 inches and 9 inches.

8. The door sill-to-jamb kit of claim 1, wherein a height of the member is predetermined between 1 inch and 3 inches.

9. A door frame assembly, comprising:
a pair of side jambs connected at their opposite ends to a head jamb for receiving a door of predetermined height and width, wherein each of the side jambs are of substantially the same width; and
a pair of door sill-to-jamb kits connected at their top surfaces to a bottom surface of each of the side jambs, and at their lateral surfaces to each end of a door sill, wherein the side jambs, the head jamb, the door sill-to-jamb kits, and the door sill form a substantially rectangular frame.

10. The door assembly of claim 9, wherein each door sill-to-jamb kit consists of at least one of plastic, polyurethane, fiberglass, and extruded wood composite.

11. The door assembly of claim 9, wherein each door sill-to-jamb kit further comprises:
at least one substantially round hole between the top surface and a bottom surface;
at least one substantially elongated protrusion on a top surface of the door sill-to-jamb kit; and
at least one substantially flat tab protruding at a right angle from a lateral surface of the door sill-to-jamb kit.

12. The door assembly of claim 9, wherein each door sill-to-jamb kit is fastened to each side jamb by employing at least one of a screw, a nail, a rivet, and a dowel through the substantially round hole and fitting the at least one substantially elongated protrusion on the top surface of the door sill-to-jamb kit to a matching groove on the bottom surface of the side jamb.

13. The door assembly of claim 9, wherein each door sill-to-jamb kit is fastened to the threshold employing the at least one substantially flat tab protruding from a lateral surface of the door sill-to-jamb kit.

14. A method for making a door sill-to-jamb kit for a door frame assembly, the method comprising:
providing a substantially rectangular member comprising a thermoplastic material, wherein a length of the member is of substantially similar to a width of a side jamb of the door frame assembly;
providing at least one substantially elongated protrusion on a top surface of the member; and
providing at least one substantially flat tab protruding at a right angle from a lateral surface of the member.

15. The method of claim 14, wherein the thermoplastic material is at least one of plastic, polyurethane, fiberglass, and extruded wood composite.

16. The method of claim 14, further comprising providing at least one substantially round hole between the top surface and a bottom surface such that the door sill-to-jamb kit is fastened to the side jamb by employing at least one of a screw, a nail, a rivet, and a dowel through the substantially round hole.

17. The method of claim 14, further comprising:
fastening the door sill-to-jamb kit to the threshold by employing the at least one substantially flat protrusion on the proximal lateral surface.

18. A method for reducing weathering effects on a wooden door frame assembly, comprising:
attaching a side jamb of the door frame assembly to a door sill employing a door sill-to-jamb kit, wherein the door sill-to-jamb kit comprises:
a substantially rectangular member comprising a thermoplastic material, wherein a length of the member is of substantially similar to a width of the side jamb;
at least one substantially elongated protrusion on a top surface of the member; and
at least one substantially flat tab protruding at a right angle from a lateral surface of the member.

19. The method of claim 18, wherein attaching the side jamb to the door sill-to-jamb kit further comprises:
fitting the at least one substantially elongated protrusion on the top surface into a substantially matching groove at a bottom surface of the side jamb; and
employing at least one of a screw, a nail, and a dowel through a top and bottom surface of the door sill-to-jamb kit for fastening to the side jamb.

20. A door sill-to-jamb kit that is resistant to weathering effects on a wooden door frame assembly, comprising:
a substantially rectangular member means consisting of at least a thermoplastic material, wherein a length of the member means is of substantially similar to a width of a side jamb of the door frame assembly;
at least one substantially elongated protrusion means on a top surface of the member means;
at least one substantially flat tab means protruding at a right angle from a lateral surface of the member means; and
at least one substantially round hole means between the top surface and a bottom surface of the member means.
